(19) United States
(12) Patent Application Publication
(10) Pub. No.: US 2023/0347305 A1
(43) Pub. Date: Nov. 2, 2023

(54) MIXING DEVICE FOR A PRIMARY FLUID FLOW IN FIRST TUBE WITH AT LEAST ONE SECONDARY FLUID FLOW, A METHOD FOR MIXING AND AIRCRAFT ENGINE

(71) Applicant: Rolls-Royce Deutschland Ltd & Co KG, Blankenfelde-Mahlow (DE)

(72) Inventors: Hubert DENGG, Rangsdorf (DE); Stefan FECHNER, Berlin (DE)

(21) Appl. No.: 18/310,885

(22) Filed: May 2, 2023

(30) Foreign Application Priority Data
May 2, 2022 (DE) 10 2022 110 733.7

(51) Int. Cl. B01F 25/433; B01F 25/431; B01F 23/10

(52) U.S. Cl. CPC B01F 25/4331; B01F 25/43163; B01F 23/10; B64D 15/04

(57) ABSTRACT

The invention relates to a mixing device for a primary fluid flow in a first pipe with at least one secondary fluid flow, characterized in that a mixing point of the fluid flows is arranged in each case at the connection of the first pipe to at least one second pipe for the at least one secondary fluid flow, and an orifice plate device for a targeted reduction in the flow cross section is arranged upstream of the mixing point in the at least one second pipe, or the first pipe has a wall section with an orifice plate device for the targeted reduction in the flow cross section, through which orifice plate device the at least one secondary fluid flow flows into the first pipe during operation. The invention furthermore relates to a mixing method and to an aircraft engine.

This application claims priority to German Patent Application 102022110733.7 filed May 2, 2022, the entirety of which is incorporated by reference herein.

The invention relates to a mixing device having the features of claim 1, to a mixing method having the features of claim 15, and to an aircraft engine having the features of claim 16.

In fluid systems, i.e. systems relating to liquids, gases and mixtures of liquids and gases, it is frequently an object to mix fluid flows with one another. Mixing is thermodynamically a process which is in principle irreversible and is intended to be undertaken as efficiently as possible from a technical aspect. It is thus an aim to reduce the mixing length as far as possible, i.e. a certain degree of mixing has to be complied with under specific conditions. Mixing length is understood here to mean a state of the mixed fluid flow, which, for example, complies with a thermal homogeneity condition.

Static mixers of fluids, in which fluid flows are thoroughly mixed using flow effects without an external drive, are known in principle. For the thorough mixing of relatively low-viscosity fluid flows, e.g. air flows, use is made here in particular of vortex shedding and turbulence.

Mixing devices of the type relevant here are known, for example, from US 2015 048004 A1 or US 2021095588 A1.

The object of efficiently mixing fluid flows is addressed by a mixing device having the features of claim 1.

The mixing device serves for mixing a primary fluid flow in a first pipe with at least one secondary fluid flow. In principle, a fluid flow can always be understood to mean a primary fluid flow, and another fluid flow or a plurality of other fluid flows then form(s) the secondary fluid flow or the secondary fluid flows.

If the two fluid flows flow in pipes, a mixing point of the fluid flows is arranged in each case at the connection of the first pipe to at least one second pipe for the at least one secondary fluid flow. Upstream of the mixing point, an orifice plate device for a targeted reduction in the flow cross section is then arranged in at least one second pipe.

If the first fluid flow is arranged in a pipe, the first pipe then has a wall section (i.e. a region which extends over part of the pipe wall) with an orifice plate device for the targeted reduction in the flow cross section, the at least one secondary fluid flow flowing into the first pipe through the orifice plate device during operation.

The orifice plate device, i.e. a means for reducing the cross section through which the flow passes, permits targeted influencing of the flow properties of the secondary fluid flow, e.g. an increase in the turbulence or an increase in the internal fluid friction. Improved thorough mixing of the fluid flows can therefore be achieved, and therefore homogeneous fluid properties are established more rapidly in the mixed flow.

In one embodiment, the orifice plate device reduces the free flow cross section for the at least one secondary fluid flow in each case by up to 85%, in particular by up to 40%. Depending on the adjusted constriction, different turbulences, and therefore different thorough mixing, are produced.

For example, here the orifice plate device can in each case have a multiplicity of openings, grids and/or rod-shaped elements through which the at least one secondary fluid flow can flow. The elements mentioned can for example influence the generation of turbulence in a targeted manner. For example, the multiplicity of openings, grids and/or rod-shaped elements of the orifice plate device can be arranged offset one behind another in the direction of the secondary fluid flow, in particular transversely with respect to the direction of flow. The plurality of parts of the orifice plate device enable the secondary fluid flow to be turned several times, which leads to a further increase in the turbulence.

In principle, the orifice plate device can be formed statically. However, it is also possible for the flow characteristics of the orifice plate device to be variable in a targeted manner. In a first embodiment, an adjustment means for adjusting the flow cross section is provided. The orifice plate device can be moved, for example, by means of a hydraulic, pneumatic and/or electric actuator in order to influence the flow of the secondary fluid flow. If, for example, a sensor is arranged in the mixed flow, the adjustment means can be coupled to a control device. If, for example, the mixing temperature (or another parameter) deviates from a desired value, the mixing result can be changed by the control device of the orifice plate device such that the desired value is reached.

Another embodiment with a variable flow characteristic for the at least one secondary fluid flow has an orifice plate device having two parts (e.g. orifice plates) which have different coefficients of linear thermal expansion. In the event of temperature changes, a predeterminable change in the flow characteristics can thus be produced. By means of the different thermal expansions, the openings through which the flow effectively passes can be changed.

In one embodiment, the primary fluid flow is unchoked at least in the region of the mixing with the at least one secondary fluid flow (i.e. there are no fittings), and therefore no significant pressure loss occurs in the primary fluid flow, e.g. due to fittings in the primary fluid flow.

In principle, the embodiments of the mixing device can be used with different types of fluids. However, specifically in aircraft engines, a frequent situation is that the primary fluid flow and/or the at least one secondary fluid flow have a portion of air or consist of air.

If the fluid flows flow in pipes, in one embodiment the first pipe is connected to the at least one second pipe at an angle, as seen in the direction of flow, of less than 180°, in particular in the range between 150 and 90°, or in particular in the range between 30 and 85°. The mixing is therefore generally undertaken in the direction of flow (angle less than 90°) or counter to the direction of flow (angle greater than 90°) of the fluid flows. If the angle is greater than 90°, the flows colliding with one another generate turbulence to a particular extent.

Efficient mixing is produced if the distance between the orifice plate device and the mixing point in the direction of flow is less than three times, in particular less than double, the characteristic diameter of the second pipe.

The at least one secondary fluid flow can also flow through the wall section of the orifice plate device at an angle of 10 to 175°. Here too, a flow component of the secondary fluid flow can be directed counter to the direction of flow of the primary fluid flow.

In one embodiment, the mixing device can be configured and designed in such a manner that the mean temperature of the mixed fluid flow deviates by less than 10% from the ideal mixing temperatures of the fluid flows, specifically as measured at a distance of 10 to 20 times the characteristic diameter of the first pipe.

One possible application of an embodiment of the mixing device is when the primary fluid flow and the at least one secondary air flow are arranged in an engine of an aircraft, in particular as part of a secondary air system, very particularly as part of a temperature control system of a nacelle.

A method having the features of claim 15 and an aircraft engine having the features of claim 16 also achieve the object.

The invention will be explained in conjunction with the exemplary embodiments illustrated in the figures. In the figures:

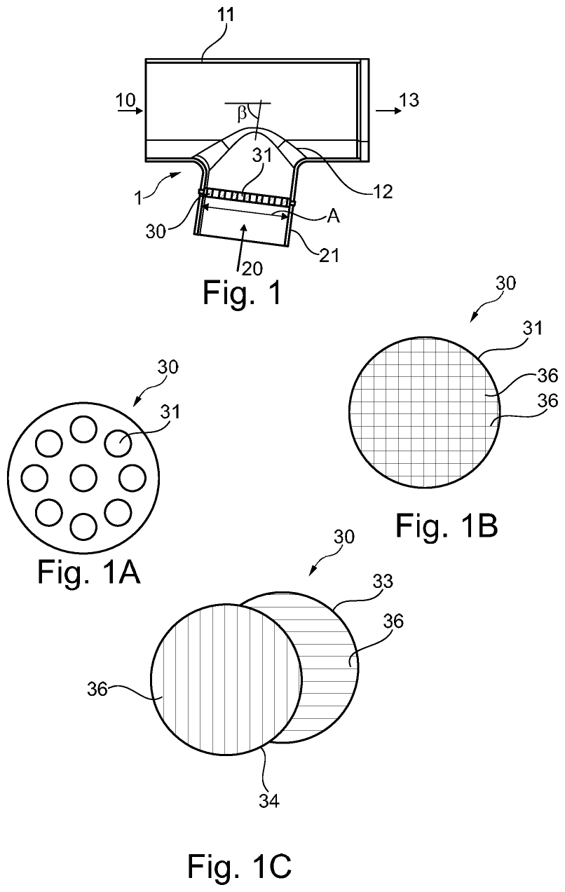

FIG. 1 shows a schematic illustration of a mixing device for a primary fluid flow with a secondary fluid flow using an orifice plate device, wherein the secondary fluid flow has a component in the direction of the primary fluid flow;

FIG. 1A shows a detailed view of a first embodiment of the orifice plate device;

FIG. 1B shows a detailed view of a second embodiment of the orifice plate device;

FIG. 10 shows a detailed view of a third embodiment of the orifice plate device;

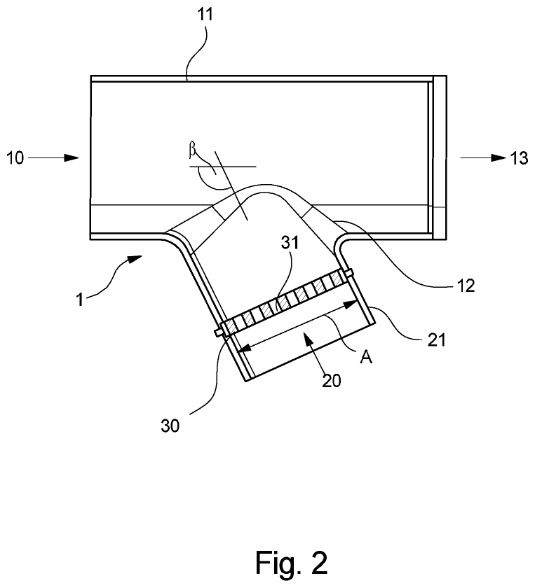

FIG. 2 shows a schematic illustration of a mixing device for a primary fluid flow with a secondary fluid flow using an orifice plate device, wherein the secondary fluid flow has a component counter to the direction of the primary fluid flow;

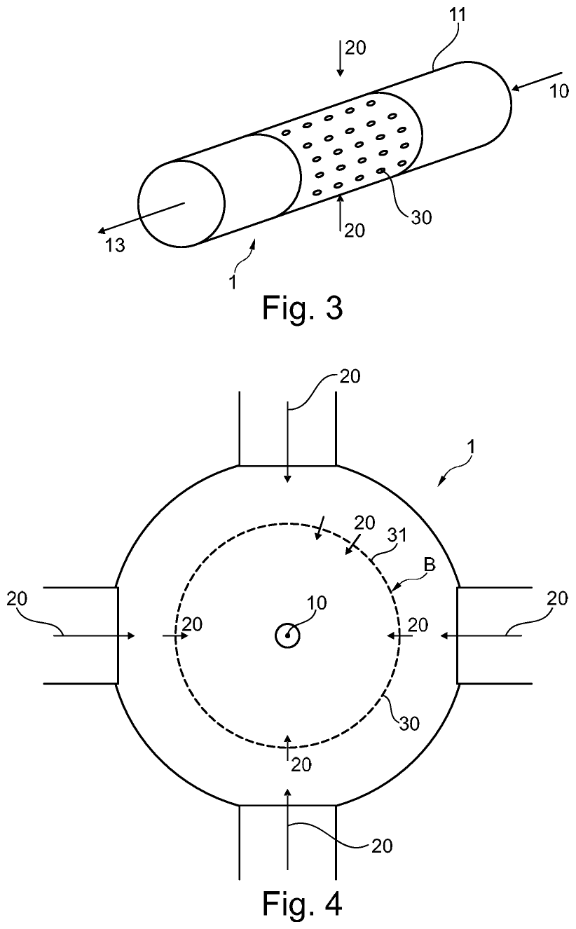

FIG. 3 shows a schematic perspective illustration of a mixing device for a primary fluid flow with a secondary fluid flow using a wall section as the orifice plate device, wherein the secondary fluid flow has a component in the direction of the primary fluid flow;

FIG. 4 shows a sectional view of a mixing device for a primary fluid flow with four secondary fluid flows using a wall section as the orifice plate device;

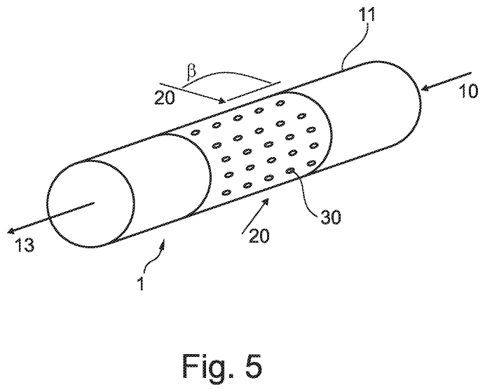

FIG. 5 shows a schematic perspective illustration of a mixing device for a primary fluid flow with a secondary fluid flow using a wall section as the orifice plate device, wherein the secondary fluid flow has a component counter to the direction of the primary fluid flow;

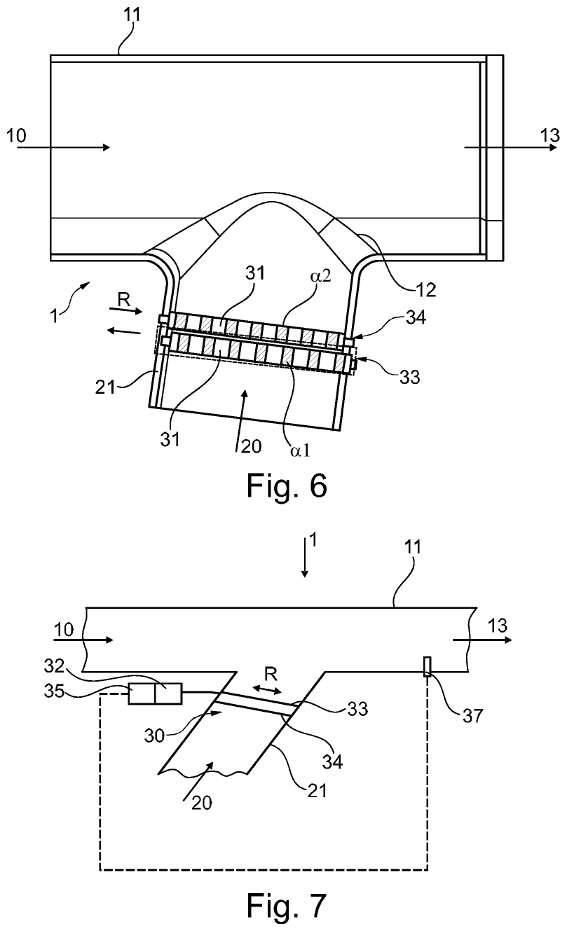

FIG. 6 shows an illustration of a first embodiment of a mixing device with an orifice plate device having an adjustable through-flow characteristic;

FIG. 7 shows an illustration of a second embodiment of a mixing device with an orifice plate device having an adjustable through-flow characteristic;

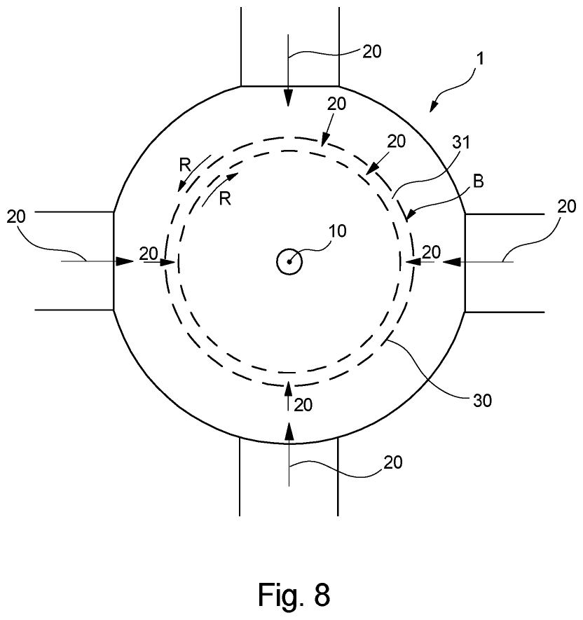

FIG. 8 shows a sectional view of a mixing device for a primary fluid flow with four secondary fluid flows using a wall section as the orifice plate device which has an adjustable through-flow characteristic.

FIG. 1 schematically illustrates the mixing of two fluid flows 10, 20 to form a mixed fluid flow 13 by means of a mixing device 1.

It is assumed by way of example below that the fluid flows 10, 20 are air flows. In principle, however, it is also possible to use embodiments of the mixing device 1 for liquid flows 10, 20 or multi-phase flows.

If the ideal gas law can be applied for the fluid flows 10, 20, this being permissible at comparatively low pressures and sufficiently high temperatures, the state variables of temperature, pressure and velocity of the mixed flow 13 are produced from the state variables of the primary air flow 10 and the secondary air flow 20 using the mass, momentum and energy balance and the ideal gas law. In any case, the mixing state of the mixed fluid flow 13 downstream of a mixing point 12 can also be determined by measuring instruments. The mixing state can be specified, for example, as a deviation of the temperature from a completely ideally thoroughly mixed flow. The ideal mixing state is approximated at increasing distance from the mixing point 12.

In FIG. 1, an unchoked primary fluid flow 10 flows in a first pipe 11. The first pipe 11 is connected to a second pipe 21, in which a secondary fluid 20 flows. Downstream of the mixing point 12, the secondary fluid flow 20 meets the primary fluid flow 10, said fluid flows then being thoroughly mixed in the first pipe 11. In the illustration in FIG. 1, the mixing point 12 is the point at which the first pipe 11 and the second pipe 12 are connected to each other.

The first pipe 11 does not have a mixing device or another means for varying the flow cross section, and therefore the primary fluid flow 10 is referred to as unchoked.

In the exemplary embodiment, the first pipe 11 is connected to the second pipe 12 at an inflow angle β, as seen in the directions of flow, of less than 90, here approx. 75°. In principle, it is also possible for the inflow angle of the secondary fluid flow 20 to also be 90° (see FIGS. 3 and 4).

Upstream of the mixing point 12, an orifice plate device 30, through which the secondary fluid flow 20 flows, is arranged in the second pipe 21.

The orifice plate device 30 has, inter alia, the task of reducing the flow cross section A of the second pipe 21. In addition, by means of flow guiding elements, e.g. openings 31 in an orifice plate (see FIG. 1A), the orifice plate device 30 can also increase the degree of turbulence and/or impress a specific pattern on the flow. The orifice plate device 30 can be understood here as a means for the targeted introduction of turbulence or of partial flows. The orifice plate device 30 in any case causes an increase in the fluid friction.

It is important in this embodiment that the orifice plate device 30 lies upstream of the mixing point 12 such that the additional turbulence is impressed, the internal friction in the secondary fluid is increased or the partial flows are formed before the secondary fluid flow 20 is mixed with the primary fluid flow 10. The distance between the orifice plate device 30 and the mixing point 12 in the direction of flow can be less than three times, in particular less than double the diameter of the second pipe 21. It is endeavored that the orifice plate device 30 should not be too far away from the mixing point.

In the embodiment illustrated with the orifice plate according to FIG. 1A, the flow cross section A is reduced by approx. 80%. In principle, smaller reductions in the flow cross section A are also possible. In the embodiment illustrated in FIG. 1, nine openings 31 are arranged in the orifice plate 30. Eight openings 31 are distributed equidistantly over the circumference; one opening 31 is arranged in the center of the orifice plate 30. In other embodiments, more or fewer than nine openings 31 and/or a different arrangement of the openings 31 can be used.

The orifice plate device 30 can also have a grid (see FIG. 1B) or rod-shaped elements, the secondary fluid flow 20 flowing through the openings 31.

The embodiments of the orifice plate devices 30 according to FIGS. 1A and 1B each have an element (orifice plate, grid) which acts on the flow of the secondary fluid flow 20.

The orifice plate device can also be more complex, as is illustrated in FIG. 10 (and also in FIG. 4). FIG. 10 schematically shows a first part 33 of the orifice plate device 30, which part has an arrangement of rods 36 in the horizontal direction. A second part 34 of the orifice plate device 30, which part has an arrangement of rods 36 in the vertical direction, is arranged downstream of said first part (in front in FIG. 10). The secondary fluid flow 20 will therefore impact successively against the two parts 33, 34 of the orifice plate device 30 such that it undergoes multiple turns.

However, it is also possible for the inflow angle of the secondary fluid flow 20 to be greater than 90°, i.e. the secondary fluid flow 20 then has a flow component which is directed toward the primary fluid flow 10 (see FIG. 2). With an embodiment according to FIG. 2, which otherwise corresponds to that of FIG. 1, the turbulence can be increased further to provide improved mixing.

In these embodiments, the positions of the parts 33, 34 relative to each other is fixed.

In conjunction with the embodiments according to FIGS. 6 to 8, the flow cross section of the second pipe 21 is adjustable, with the parts of the orifice plate device 30 being movable relative to one another, which will be explained in more detail below.

In any case, downstream of the orifice plate device 30, the degree of turbulence and/or the fluid friction of the secondary fluid flow 20 is higher than previously. There can therefore be more rapid thorough mixing with the first fluid flow 10. This means that the mixed fluid flow 30 is sufficiently homogenized more rapidly, i.e. after a shorter distance from the mixing point 12.

The mean temperature of the mixed fluid flow 13 after mixing with the secondary fluid flow 20 at a distance of 10 to 20 times the diameter of the first pipe 11 can thus deviate after the mixing by less than 10% from the ideal mixing temperatures of the fluid flows 10, 20.

In the embodiment illustrated, the pipes 11, 12 have a circular cross section. Other embodiments can deviate therefrom. The pipes 11, 12 can also have an elliptical or polygonal cross section. The cross sectional shapes of the two pipes 11, 12 also do not have to be identical, and therefore, for example, a first pipe 11 with a circular cross section can be connected to a second pipe 21 with a square cross section. If the pipe cross sections deviate from the circular shape, the relevant characteristic cross section in terms of flow of the first pipe 11 and/or of the second pipe 21 should in each case be set for the previously described distance of the orifice plate device 30 from the mixing point and the location of the measurement of the mixed fluid flow 13, as is set, e.g., when determining the Reynolds' number.

As mentioned above, a mixing variable, e.g. the temperature of the mixed flow 13, can be calculated, specifically also under ideal conditions, such as the assumption of the ideal gas law. With the embodiments illustrated here, it is possible in principle to approximate to less than 10% of this value over a relatively short distance (10-20 times the pipe diameter).

The previously illustrated embodiments of the mixing devices 1 show two pipes 11, 21 which are connected to each other. A primary fluid flow 10 can therefore be mixed with a secondary fluid flow 20. In principle, it is also possible to mix more than one secondary fluid flow 20 with the primary fluid flow 10 by more than one second pipe 21 being connected to the first pipe 11.

The mixing devices 1 illustrated also assumed that the orifice plate device 30 is arranged upstream of the mixing point 12 in at least one second pipe 21.

The position of the orifice plate device 30 relative to the fluid flows 10, 20 can also be formed differently, as is the case in the embodiments according to FIGS. 3 to 5 and 8.

In the embodiment of the mixing device 1 according to FIG. 3, the first pipe 11 for a primary fluid flow 10 has a wall section B with an orifice plate device 30 through which at least one secondary flow 20 (here two flows 20 which impact perpendicularly on the wall section B, illustrated schematically) flows into the first pipe 11 such that a mixed flow 13 arises. The orifice plate device 30 is designed here, for example, as a perforated wall (also see FIG. 3, for example) which serves for the targeted reduction in the flow cross section for the secondary fluid flows 20. The fluid flows 10, 20 are then mixed in the first pipe 11, as in the exemplary embodiments according to FIGS. 1, 1A, 1B and 10.

In the embodiment illustrated, the wall region B with the orifice plate device 30 completely surrounds the circumference of the first pipe 11. This does not always have to be the case; the orifice plate device 30 can also extend only over part of the pipe circumference.

FIG. 4 illustrates, in a sectional view, a modification of the embodiment according to FIG. 3, i.e. the first pipe 11 is shown here in a cross section, with the orifice plate device 30 extending over the entire circumference. The orifice plate device 30 has openings 31 which, as in the embodiment according to FIG. 1, produce a targeted reduction in the flow cross section for the inflowing secondary fluid flows 20.

Illustrated in the embodiment according to FIG. 4 are four secondary fluid flows 20, which, in each case offset by 90°, flow onto the wall region B with the orifice plate device 30 in order subsequently to be mixed with the primary fluid flow 10. Also in this embodiment, the mixing of the fluids by the orifice plate device 30 is improved.

As also in the embodiment of FIG. 2, secondary fluid flows 20 can also have a flow component in the direction of the primary fluid flow 10; i.e. the inflow angle β is greater than 90°. FIG. 5 shows a modification of the embodiment according to FIG. 3, in which the inflow angle β is greater than 90°.

The embodiments according to FIGS. 1 to 5 comprise static mixers since the orifice plate device 30 is formed in a spatially fixed fashion in relation to the pipes 11, 12. Apart from changes in the through-flowing second fluid flow 20 itself, the flow characteristics of the orifice plate device 30 cannot be varied.

FIGS. 6 to 8 now illustrate embodiments in which the flow characteristics of the orifice plate device 30 can be varied in a targeted way.

FIG. 6 illustrates an embodiment of an orifice plate device 30 in conjunction with a pipe connection according to the embodiment according to FIG. 1, in which the orifice plate device 30 is adjustable. The adjustability is achieved in that the orifice plate device 30 has two orifice plates 33, 34, which are arranged one behind another in the direction of flow. The holes 31 in the orifice plates 33, 34 are arranged here in a predetermined manner relative to one another, e.g. precisely congruently, which would correspond to the embodiment in FIG. 1A.

However, the two orifice plates 33, 34 are now produced with materials having different coefficients of thermal expansion α₁, α₂. If, for example, the temperature of the secondary fluid flow 20 is increased, the orifice plates 33, 34 are moved relative to one another (double arrow R in FIG. 4) without energy being supplied from outside the second pipe 21. The relative movement R of the orifice plates 33, 34 with respect to each other also changes the orientation of the openings 31 of the orifice plates 33, 34 with respect to one another. Consequently, the flow characteristics of the orifice plate device 30 are also changed since the cross section through which the secondary fluid flow 20 can pass is changed; it becomes larger or smaller, depending on the desired adaptation.

The orifice plates 33, 34 can be produced, for example, from different metals since the coefficients of linear thermal expansion of different metals may be completely different (e.g. iron 11.8*10⁻⁶/K, aluminum 23.1*10⁻⁶/K), and therefore the flow characteristics are adjustable. The greater the difference between the coefficients of linear thermal expansion, the more the adjustability can vary. In the case of plastics, the coefficients of linear thermal expansion can vary within comparatively wide ranges (e.g. rigid PVC 240*10⁻⁶/K, polyester 80*10⁻⁶/K). There are even greater variation options if one orifice plate 33 is formed from metal and the other orifice plate 34 is formed from plastic.

The concept of the orifice plate device 30 with the parts 33, 34 having different coefficients of linear thermal expansion α₁, α₂ can also be transferred to the embodiments of FIGS. 2, 3 and 4 since the orifice plate device 30 can have two perforated layers in the wall region B, the materials of which layers have different coefficients of linear thermal expansion α₁, α₂.

FIG. 7 illustrates a variation of the embodiment according to FIG. 1, and therefore reference can be made to the corresponding description.

The orifice plate device 30 here likewise has two orifice plates 33, 34 which are displaceable relative to each other (double arrow R). However, an external means 32 for adjusting the flow cross section is provided here, namely a drive (e.g. electric, hydraulic, pneumatic) which can displace the one orifice plate 33 relative to the other orifice plate 34. As in the embodiment according to FIG. 6, an adjustable free flow cross section is therefore produced in a targeted manner for the secondary fluid flow 20.

Optionally, a control device 35 which is coupled to a sensor (e.g. a temperature sensor 37) in the mixed fluid flow 13 is also provided here. If the sensor 37 determines a deviation from a desired value, the control device 35 can change the through-flow via the means 32 for adjusting the flow cross section.

This embodiment can also be adapted to an embodiment according to FIGS. 3 to 5 by, for example, the orifice plate device 30 having two curved orifice plates 33, 34 in the wall as wall regions B which are arranged displaceably relative to one another along the first pipe 11. This is illustrated in FIG. 8, in which two concentric wall regions B with orifice plates are illustrated. By a relative displacement of the wall regions B in the axial and/or radial direction (double arrow R), the orientation of the openings 31 with respect to one another is changed, and therefore the flow characteristics can be adjusted. A control device according to the embodiment of FIG. 7 can also be used here.

Embodiments of the type described here can be used, for example, in air conditioning systems or in the thermal management of the secondary air flow in an aircraft engine. Thus, for example, air flows in an anti-icing system can be efficiently mixed with one another.

### LIST OF REFERENCE SIGNS

1 mixing device
10 primary fluid flow
11 first pipe
12 mixing point
13 mixed fluid flow
20 secondary fluid flow
21 second pipe
30 orifice plate device
31 opening, hole
32 means for adjusting the flow cross section
33 first part of the orifice plate device, first orifice plate
34 second part of the orifice plate device, second orifice plate
35 control device for adjusting the flow cross section
36 rod
A flow cross section
B wall section
R relative movement between parts of an orifice plate device
α₁ coefficient of linear thermal expansion of the first part of the orifice plate device
α₂ coefficient of linear thermal expansion of the second part of the orifice plate device
β angle of inclination of a secondary fluid flow in relation to the primary fluid flow

1. A mixing device for a primary fluid flow in a first pipe with at least one secondary fluid flow for obtaining a mixed flow,
wherein
a mixing point of the fluid flows is arranged in each case at the connection of the first pipe to at least one second pipe for the at least one secondary fluid flow, and an orifice plate device for a targeted reduction in the flow cross section is arranged upstream of the mixing point in at least one second pipe,
or
the first pipe has a wall section with an orifice plate device for the targeted reduction in the flow cross section, through which orifice plate device the at least one secondary fluid flow flows into the first pipe during operation.

2. The mixing device as claimed in claim 1, wherein the orifice plate device reduces the free flow cross section for the at least one secondary fluid flow in each case by up to 85%, in particular by up to 40%.

3. The mixing device as claimed in claim 1, wherein the orifice plate device in each case has a multiplicity of openings, grids and/or rod-shaped elements through which the at least one secondary fluid flow can flow.

4. The mixing device as claimed in claim 1, wherein the multiplicity of openings, grids and/or rod-shaped elements of the orifice plate device are arranged offset one behind another in the direction of the secondary fluid flow, in particular transversely with respect to the direction of flow.

5. The mixing device as claimed in claim 1, wherein the flow characteristics of the orifice plate device are variable.

6. The mixing device as claimed in claim 5, characterized by an adjustment means for adjusting the flow cross section, in particular by means of hydraulic, pneumatic and/or electric adjustment, the adjustment means in particular being coupled to a control device.

7. The mixing device as claimed in claim 5, wherein the orifice plate device has two parts with different coefficients of thermal expansion.

8. The mixing device as claimed in claim 1, wherein the primary fluid flow is unchoked at least in the region of the mixing with the at least one secondary fluid flow.

9. The mixing device as claimed in claim 1, wherein the primary fluid flow and/or the at least one secondary fluid flow have a portion of air or consist of air.

10. The mixing device as claimed in claim 1, wherein the first pipe is connected to the at least one second pipe at an angle, as seen in the direction of flow, of less than 180°, in particular in the range between 150 and 90°, or in particular in the range between 30 and 85°.

11. The mixing device as claimed in claim 1, wherein the distance between the orifice plate device and the mixing point in the direction of flow is less than three times, in particular less than double, the characteristic diameter of the second pipe.

12. The mixing device as claimed in claim 1, wherein the at least one secondary fluid flow flows through the wall section of the orifice plate device at an angle of 10 to 175°.

13. The mixing device as claimed in claim 1, wherein it is configured and designed in such a manner that the mean temperature of the mixed fluid flow at a distance of 10 to 20 times the characteristic diameter of the first pipe deviates by less than 10% from the ideal mixing temperature of the fluid flows.

14. The mixing device as claimed in claim 1, wherein the primary fluid flow and the at least one secondary air flow are arranged in an engine of an aircraft, in particular as part of a secondary air system, very particularly as part of a temperature control system of a nacelle.

15. A method for mixing a primary fluid flow in a first pipe with at least one secondary fluid flow,
wherein
the fluid flows are mixed at a mixing point at the connection of the first pipe to at least one second pipe for the at least one secondary fluid flow, and an orifice plate device for targeted generation of a turbulent flow and/or for imparting a flow pattern in the at least one secondary fluid flow is arranged upstream of the mixing point in the at least one second pipe,
or
the first pipe has a wall section with an orifice plate device for the targeted reduction in the flow cross section, through which orifice plate device the at least one secondary fluid flow flows into the first pipe.

16. An aircraft engine having at least one mixing device as claimed in claim 1.
